(19) United States
(12) Patent Application Publication
(10) Pub. No.: US 2012/0177791 A1
(43) Pub. Date: Jul. 12, 2012

(54) METHOD FOR MANUFACTURING REFINED FATS AND OILS

(75) Inventors: Minoru Kase, Kamisu-shi (JP); Tetsuya Abe, Kamisu-shi (JP); Toshiteru Komatsu, Kamisu-shi (JP); Keiji Shibata, Kamisu-shi (JP)

(73) Assignee: KAO CORPORATION, Chuo-ku, Tokyo (JP)

(21) Appl. No.: 13/496,755

(22) PCT Filed: Sep. 15, 2010
(86) PCT No.: PCT/JP2010/065939

§ 371 Date: Mar. 16, 2012

(30) Foreign Application Priority Data
Sep. 16, 2009 (JP) 2009-214949

(51) Int. Cl. A23D 7/04; A23D 9/04

(52) U.S. Cl. 426/254; 426/417

(57) ABSTRACT

Provided is a method for manufacturing refined fats and oils, including: a treating fats and oils by bringing the fats and oils into contact with water vapor or inert gas; and subsequently performing thin-film evaporation of the fats and oils.

### FIELD OF THE INVENTION

The present invention relates to a method for manufacturing refined fats and oils.

### BACKGROUND OF THE INVENTION

Fats and oils are essential for a human body as nutrients and source of energy supply (the primary function), and moreover, are important for providing so-called sensory function (the secondary function), which satisfies palatability of foods, for example, taste or aroma. In addition, fats and oils containing diacylglycerols at a high concentration show physiological effects (the third function) such as body fat-burning effect, and are widely used by health-conscious consumers.

The fats and oils contain impurities such as fatty acids, monoacylglycerols, and odor components, and it is necessary to improve taste and flavor by removing these impurities in order to use the fats and oils as edible oils. Thus, a process of so-called deodorization, in which the fats and oils are brought into contact with water vapor under reduced pressure at high temperature, is generally performed (Patent Document 1).

### PRIOR ART DOCUMENT

### Patent Document

[Patent Document 1] JP-B-H03-7240

### SUMMARY OF THE INVENTION

The present invention provides a method for manufacturing refined fats and oils, including treating fats and oils by bringing the fats and oils into contact with water vapor or inert gas; and subsequently performing thin-film evaporation on the fats and oils.

Embodiment for Carrying out the Invention [0006] In recent years, consumer demand for improvement of quality of edible fats and oils has been largely growing, and consumers who are sensitive to taste and flavor has been remarkably increased. Thus, fats and oils having better taste and flavor than conventional ones are desired.

However, in conventional technique, increasing of purity of fats and oils for improving taste and flavor is difficult because there are problems that the acid value remains unchanged the content of monoacylglycerols was not easily reduced, and consequently, harsh taste occurred. In particular, such tendency was remarkable in fats and oils having a high content of diacylglycerols.

Thus, the present invention relates to providing a method for manufacturing fats and oils having low acid value, low content of monoacylglycerols, and good taste and flavor.

The inventors of the present invention have made various efforts for studying refining operation of fats and oils, and have found that fats and oils having reduced acid value, reduced content of monoacylglycerols, and good taste and flavor can be obtained through treating fats and oils by bringing the fats and oils into contact with water vapor or inert gas, and subsequently performing thin-film evaporation on the fats and oils.

According to the present invention, refined fats and oils having low acid value, low content of monoacylglycerols, and good taste and flavor are provided.

Fats and oils used for the manufacturing method of the present invention refer to fats and oils containing triacylglycerols and/or diacylglycerols. Any kinds of vegetable fats and oils and animal fats and oils may be used as the fats and oils. Specific examples of raw materials include rapeseed oil, sunflower oil, corn oil, soybean oil, rice oil, safflower oil, cotton seed oil, beef tallow, linseed oil, and fish oil.

Fatty acids and monoacylglycerols are easily produced by using diacylglycerols in refining step as compared with using triacylglycerols. Thus, it is more preferred to use fats and oils containing diacylglycerols in manufacturing method of the present invention. The content of diacylglycerols is preferably 50 weight % (hereinafter, simply described as “%”) or more, more preferably 60% or more, and even more preferably 80% or more. The upper limit of the content is not particularly defined, and is preferably 99% or less, more preferably 98% or less, and even more preferably 95% or less.

The fats and oils containing diacylglycerols can be obtained through esterification reaction between fatty acids, derived from fats and oils, and glycerin, transesterification reaction between fats and oils and glycerin, or the like. These reactions are preferably carried out under enzymatically mild conditions by using a 1,3-position selective lipase or the like in view of obtaining excellent taste and flavor or the like.

Refining step that is generally used for fats and oils may be carried out before or after the manufacturing step of the fats and oils of the present invention. Specific examples thereof include top cut distillation step, acid treatment step, decoloration step, and water washing step.

The top cut distillation step refers to a step of distillation of fats and oils, thereby removing light weight by-products such as fatty acids from the fats and oils.

The acid treatment step refers to a step of adding chelating agents such as citric acid to fats and oils, followed by mixing them, and subsequently subjecting the mixture to dehydration under reduced pressure, thereby removing impurities.

The decoloration step refers to a step of bringing an adsorbent or the like into contact with fats and oils, thereby additionally improving its hue and its taste and flavor.

The water washing step refers to a step of bringing fats and oils into contact with water, thereby performing oil-water separation. Water washing can remove water-soluble impurities. The water washing step is preferably repeated more than once (for example, three times).

In the manufacturing method of the present invention, the step of bringing fats and oils into contact with water vapor or inert gas (hereinafter, also referred to as first steaming treatment) is at first carried out. Examples of the inert gas include nitrogen, helium, and argon. Of these, nitrogen is preferred. Water vapor is preferred as a gas with which the fats and oils are brought into contact, from the viewpoint of being able to provide a better taste and flavor.

A method of bringing fats and oils into contact with water vapor or inert gas is not particularly limited, and it maybe performed by batchwise method, a semi-continuous method, a continuous method, or the like. When the amount of fats and oils to be treated is small, the batch method is preferably used, and when the amount is large, the semi-continuous method or the continuous method is preferably used.

Example of apparatus for the semi-continuous method includes a Girdler type deodorization apparatus composed of a deodorization tower equipped with several trays. The treatment is performed in this apparatus by supplying fats and oils for deodorization from the upper part of the apparatus, bringing the fats and oils into contact with water vapor or inert gas in the tray for appropriate period of time, and supplying the fats and oils to the next lower tray so that the fats and oils are successively moved down intermittently.

Example of apparatus for the continuous method includes a thin-film deodorization apparatus filled with structures in which fats and oils in a thin-film form can be brought into contact with water vapor.

The temperature at which fats and oils are brought into contact with water vapor or inert gas is preferably 200 to 280° C. This temperature is, from the standpoints of the efficiency of treatment and the taste and flavor, preferably 230 to 280° C., more preferably 235 to 275° C., and even more preferably 265 to 275° C.

The time for contact is preferably 1 to 15 minutes, more preferably 1 to 10 minutes, and even more preferably 2 to 10 minutes.

The pressure is preferably 0.02 to 2 kPa, more preferably 0.05 to 1 kPa, and even more preferably 0.1 to 0.8 kPa.

The amount of water vapor or inert gas with which fats and oils are brought into contact is, preferably 0.1 to 10%, more preferably 0.2 to 5%, and even more preferably 0.2 to 2%, relative to the amount of fats and oils.

In the present invention, subsequently thin-film evaporation treatment is performed on the fats and oils.

The thin-film evaporation treatment refers to a treatment in which a material for distillation is formed into a thin film and heated, to thereby evaporate light cut fraction from fats and oils, and thus to obtain the fats and oils resulting from the treatment as a residual fraction. The treatment is carried out by using a thin-film evaporation apparatus. Examples of the thin-film evaporation apparatus include a centrifugal thin-film evaporation apparatus, a falling film evaporation apparatus, and a wiped film distillation apparatus, which are each used depending on methods of forming a thin film.

Of those, the wiped film distillation apparatus is preferably used in order to prevent local overheat of the fats and oils and to avoid the thermal degradation of the fats and oils. The wiped film distillation apparatus is an apparatus in which a material for distillation is poured on the inside of a tubular evaporation surface so as to form a thin film, the thin film is stirred with a wiper, and the thin film is heated from the outside, thereby evaporating a fraction. A wiped film distillation apparatus having an internal condensing system for condensing the fractions is preferred, from the standpoint of reducing vacuum resistance, thereby reducing the running cost of a vacuum device, and the standpoint of improving evaporation capacity. Examples of the wiped film distillation apparatus include “a short path distillation apparatus” manufactured by UIC GmbH, “WIPRENE” manufactured by Shinko Pantec Co., Ltd., and “Kontro” manufactured by Hitachi, Ltd.

As a condition of the thin-film evaporation treatment, pressure is preferably 2 to 300 Pa, more preferably 3 to 200 Pa, even more preferably 3 to 100 Pa, and even more preferably 3 to 90 Pa, from the standpoint of reducing facility cost and running cost, the standpoint of improving distillation capacity, the standpoint of easily selecting the optimal distillation temperature, the standpoints of decreasing acid value and amount of monoacylglycerols, and adding better taste and flavor.

The temperature is preferably 180 to 280° C., more preferably 190 to 260° C., even more preferably 195 to 250° C., and even more preferably 210 to 245° C., from the standpoint of yielding fats and oils having smaller acid value, lower content of monoacylglycerols and better taste and flavor.

The retention time is preferably 0.05 to 10 minutes, more preferably 0.08 to 5 minutes, and even more preferably 0.1 to 1 minute, from the standpoint of yielding fats and oils having smaller acid value and lower content of monoacyglycerols and better taste and flavor.

The thinner the film thickness of fats and oils in the apparatus is, the more improved the efficiency of its treatment is, which is preferred. The film thickness is not particularly limited, and the thickness of a film provided by a commercially available thin-film evaporation apparatus is satisfactory as the film thickness. The film thickness is preferably 10 mm or less, and more preferably 2 mm or less.

The steaming treatment and the thin-film evaporation treatment can reduce the acid value and the content of monoacylglycerols of the resultant fats and oils, and can remarkably improve harsh taste of the fats and oils. Here, the term “harsh taste” refers to the taste and flavor involving astringency left in aftertaste in the mouth. Note that although the evaluation on the heaviness of taste and flavor slightly decreases after the thin-film evaporation treatment, the heaviness is still within a range which is fully acceptable for consumers. Here, the term “heaviness of taste and flavor” refers to a viscous and sticking sense in the mouth.

In the present invention, it is preferred to carry out a treatment of bringing the fats and oils into contact with water vapor or inert gas again (also referred to as second steaming treatment) after the thin-film evaporation treatment is performed.

The conditions of the second steaming treatment are preferably milder than those of the first steaming treatment. Specifically, the second steaming treatment is preferably carried out at a temperature lower than that at which the first steaming treatment is carried out, more preferably at a temperature of lower by 10° C. or more, even more preferably lower by 20° C. or more, even more preferably lower by 50° C. or more, and even more preferably lower by 90° C. or more. The treatment temperature is preferably 120 to 220° C., more preferably 140 to 200° C., and even more preferably 160 to 180° C. The contact time is preferably 1 to 60 minutes, more preferably 1 to 40 minutes, even more preferably 2 to 30 minutes, and even more preferably 10 to 30 minutes. The pressure is preferably 0.02 to 2 kPa, more preferably 0.05 to 1 kPa, and even more preferably 0.1 to 0.8 kPa. The amount of water vapor or inert gas with which the fats and oils are brought into contact, is, with respect to the amount of the fats and oils, preferably 0.1 to 10%, and more preferably 0.5 to 6%.

The second steaming treatment can improve the heaviness of taste and flavor of the resultant refined fats and oils and can also further improve its harsh taste.

The fats and oils, in particular, the diacylglycerols-rich fats and oils, produced through treatment by the method of the present invention, have lower acid value and content of monoacylglycerols, decreased harsh taste and heaviness of taste and improved flavor, therefore, fats and oils that are highly acceptable to consumers are provided.

The acid value of the refined fats and oils is preferably 0.05 or less, more preferably 0.04 or less, and even more preferably 0.02 or less. The content of monoacylglycerols is preferably 0.5% or less, more preferably 0.4% or less, and even more preferably 0.3% or less.

### EXAMPLES

[Method for Analysis]

[Acid Value]

The acid value was measured according to the method described in the American Oil Chemists. Society Official Method Ca 5a-40. The unit of the acid value is “mg-KOH/g,” description of which is omitted from the present specification.

[Contents of Monoacylglycerols and of Diacylglycerols]

Approx. 10 mg of sample and 0.5 mL of trimethylsilylating agent (“Silylating Agent TH” manufactured by Kanto Chemical Co., Inc.) were loaded into a glass sample bottle, hermetically sealed and heated at 70° C. for 15 minutes. 1.5 mL of water and 1.5 mL of hexane were added thereto, followed by shaking. After standing still, the upper layer was subjected to gas chromatography (GLC) for analysis.

[Taste and Flavor]

The evaluation of taste and flavor of each refined fats and oils (heaviness and harsh taste) was performed by panelists consist of five members. Each member ate 1 to 2 g of the each refined fats and oils raw, and performed a sensory evaluation based on the criteria shown below. The average of the five evaluations was rounded off to the nearest whole number. Note that when the refined fats and oils are evaluated as 3 or higher, the fats and oils are determined to be highly accepted by consumers.

### [Criteria for Evaluation of Taste and Flavor]

5: Very good

4: Good

3: Slightly good

2: Poor

1: Very poor

[Preparation of Material Fats and Oils]

100 parts by weight of mixed fatty acids (soybean oil fatty acids:rapeseed oil fatty acids=7:3 (weight ratio)) and 15 parts by weight of glycerin were mixed, and the mixture was subjected to esterification reaction with an enzyme. From the resultant esterified product, fatty acids and monoacylglycerols were removed by distillation, treated with acid (10% aqueous solution of citric acid was added in an amount of 2%) and washed with water (three times with distilled water), to yield diacylglycerols-containing fats and oils (containing 91% of diacylglycerols).

### Example 1

The diacylglycerols-containing fats and oils were subjected to first steaming treatment under the conditions of temperature of 270° C., pressure of 0.3 kPa, time of 5 minutes, and a ratio of water vapor/material of 0.6%. Note that the first steaming treatment was carried out by using a continuous thin-film deodorization apparatus filled with structures as shown in the following examples and comparative examples.

After that, a wiped film distillation apparatus (2-03 type manufactured by Shinko Pantec Co., Ltd., inner diameter: 5 cm, heat transmission area: 0.03 m², film thickness: 1 mm) was used to remove low-boiling-point components under the operation conditions of heater temperature of 200° C., pressure of 40 Pa, and contact time of 0.3 minute, to yield refined fats and oils.

### Example 2

Refined fats and oils were obtained in the same manner as in Example 1, except that the temperature of the heater in the wiped film distillation apparatus was set to 240° C.

### Example 3

The diacylglycerols-containing fats and oils were subjected to first steaming treatment under the conditions of temperature of 270° C., pressure of 0.3 kPa, time of 5 minutes, and a ratio of water vapor/material of 0.6%.

After that, the wiped film distillation apparatus (2-03 type manufactured by Shinko Pantec Co., Ltd., inner diameter: 5 cm, heat transmission area: 0.03 m²) was used to remove low-boiling-point components under the operation conditions of heater temperature of 240° C., pressure of 40 Pa, and contact time of 0.3 minute.

After that, a batch deodorization apparatus was additionally used to subject the resultant fats and oils to second steaming treatment under the conditions of temperature of 180° C., pressure of 0.4 kPa, time of 30 minutes, and a ratio of water vapor/material of 1.5%, to yield refined fats and oils.

### Comparative Example 1

The diacylglycerols-containing fats and oils were subjected to first steaming treatment under the conditions of temperature of 270° C., pressure of 0.3 kPa, time of 5 minutes, and a ratio of water vapor/material of 0.6%.

### Comparative Example 2

The diacylglycerols-containing fats and oils ware subjected to first steaming treatment under the conditions of temperature of 270° C., pressure of 0.3 kPa, time of 5 minutes, and a ratio of water vapor/material of 0.6%.

After that, batch simple distillation was carried out under the conditions of temperature of 200° C., pressure of 400 Pa, and time of 60 minutes, to remove low-boiling-point components.

### Comparative Example 3

The diacylglycerols-containing fats and oils were subjected to first steaming treatment under the conditions of temperature of 270° C., pressure of 0.3 kPa, time of 5 minutes, and a ratio of water vapor/material of 0.6%.

After that, a batch deodorization apparatus was used to subject the resultant fats and oils to second steaming treatment under the conditions of temperature of 180° C., pressure of 0.4 kPa, time of 30 minutes, and a ratio of water vapor/material of 1.5%.

The results are shown in Table 1.

In the case where only the first steaming treatment was carried out (Comparative Example 1), the resultant fats and oils had high acid value, high content of monoacylglycerols (MG), and harsh taste. However, in the case where the low-boiling-point components were removed through the thin-film evaporation treatment after the first steaming treatment (Examples 1 and 2), refined fats and oils of good quality were yielded.

Besides, in the case where the steaming treatment was again carried out (Example 3) after the low-boiling-point components were removed through the thin-film evaporation treatment, refined fats and oils of better quality were yielded.

On the other hand, refined fats and oils having good quality cannot be yielded when the fats and oils which had been obtained by the first steaming treatment was subjected to the evaporation treatment by simple distillation (Comparative Example 2), and was subjected to second steaming treatment without being subjected to the thin-film evaporation treatment (Comparative Example 3).

TABLE 1

| | | | | | | | | | Comparative | | Comparative | | Comparative | |
|---|---|---|---|---|---|---|---|---|---|---|---|---|---|---|
| | | | Example 1 | | Example 2 | | Example 3 | | Example 1 | | Example 2 | | Example 3 | |
| Treatment | First | Temperature | 270° | C. | 270° | C. | 270° | C. | 270° | C. | 270° | C. | 270° | C. |
| steps | steaming | Pressure | 0.3 | kPa | 0.3 | kPa | 0.3 | kPa | 0.3 | kPa | 0.3 | kPa | 0.3 | kPa |
| | | Contact | 5 | minutes | 5 | minutes | 5 | minutes | 5 | minutes | 5 | minutes | 5 | minutes |
| | | time | | | | | | | | | | | | |

| | Weight | 0.6% | | 0.6% | | 0.6% | | 0.6% | 0.6% | | 0.6% |
|---|---|---|---|---|---|---|---|---|---|---|---|
| | ratio of | | | | | | | | | | |
| | water | | | | | | | | | | |
| | vapor/fats | | | | | | | | | | |
| | and oils | | | | | | | | | | |
| Thin-film | Apparatus | Thin film | | Thin film | | Thin film | | — | Simple | | — |
| evaporation | | | | | | | | | distillation | | |
| treatment | Temperature | 200° | C. | 240° | C. | 240° | C. | — | 200° | C. | — |
| | Pressure | 40 | Pa | 40 | Pa | 40 | Pa | — | 400 | Pa | — |
| | Contact | 0.3 | minute | 0.3 | minute | 0.3 | minute | — | 60 | minutes | — |
| | time | | | | | | | | | | |

| | | | | | | | | | |
|---|---|---|---|---|---|---|---|---|---|
| Second | Temperature | — | — | 180° | C. | — | — | 180° | C. |
| steaming | Pressure | — | — | 0.4 | kPa | — | — | 0.4 | kPa |
| | Contact | — | — | 30 | minutes | — | — | 30 | minutes |
| | time | | | | | | | | |

| | | | | | | | | |
|---|---|---|---|---|---|---|---|---|
| | | Weight | — | — | 1.5% | — | — | 1.5% |
| | | ratio of | | | | | | |
| | | water | | | | | | |
| | | vapor/fats | | | | | | |
| | | and oils | | | | | | |
| Analysis | Acid value | | 0.04 | 0.03 | 0.02 | 0.12 | 0.06 | 0.04 |
| value | MG | | 0.4 | 0.1 | 0.1 | 0.5 | 0.6 | 0.6 |
| Evaluation on | Heaviness | | 3 | 3 | 5 | 4 | 1 | 5 |
| taste and | Harsh taste | | 3 | 4 | 5 | 1 | 1 | 2 |
| flavor | | | | | | | | |

1. A method for manufacturing refined fats and oils, comprising:
treating fats and oils by bringing the fats and oils into contact with water vapor or insert gas; and
subsequently performing thin-film evaporation on the fats and oils.

2. The method for manufacturing refined fats and oils according to claim 1, further comprising carrying out a treatment of bringing the fats and oils into contact with water vapor or inert gas again after the thin-film evaporation treatment is performed.

3. The method for manufacturing refined fats and oils according to claim 2, wherein a temperature of the treatment of bringing the fats and oils into contact with water vapor or inert gas again is lower by 10° C. or more than a temperature of the preceding treatment of bringing the fats and oils into contact with water vapor or inert gas.

4. The method for manufacturing refined fats and oils according to claim 2, wherein the temperature of the treatment of bringing the fats and oils into contact with water vapor or inert gas again is 120 to 220° C.

5. The method for manufacturing refined fats and oils according to claim 1, wherein the fats and oils comprise diacylglycerols in an amount of 50 weight % or more.

6. The method for manufacturing refined fats and oils according to claim 1, wherein the fats and oils comprise diacylglycerols in an amount of from 60 to 99 weight %.

7. The method for manufacturing refined fats and oils according to claim 1, wherein a temperature at which the fats and oils are brought into contact with water vapor or inert gas is 200 to 280° C.

8. The method for manufacturing refined fats and oils according to claim 1, wherein an amount of the water vapor or inert gas with which the fats and oils are brought into contact is 0.1 to 10%.

9. The method for manufacturing refined fats and oils according to claim 1, wherein the thin-film evaporation on the fats and oils is carried out to evaporate light cut fraction from fats and oils and to obtain the fats and oils resulting from the treatment as a residual fraction.

10. The method for manufacturing refined fats and oils according to claim 1, wherein pressure at which the thin-film evaporation treatment is performed is 2 to 300 Pa.

11. The method for manufacturing refined fats and oils according to claim 1, wherein a temperature at which the thin-film evaporation treatment is performed is 180 to 280° C.

12. The method for manufacturing refined fats and oils according to claim 1, further comprising, prior to bringing the fats and oils into contact with water vapor or inert gas, at least one of:
distilling, by top cut distillation, the fats and oils,
acid treating the fats and oils,
contacting the fats and oils with an adsorbent to decolor the fats and oils, and
washing the fats and oils with water.

13. The method for manufacturing refined fats and oils according to claim 2, wherein an amount of the water vapor or inert gas with which the fats and oils are brought into contact is 0.1 to 10%.
